(19) United States
(12) Patent Application Publication
(10) Pub. No.: US 2020/0264329 A1
(43) Pub. Date: Aug. 20, 2020

(54) VISUALIZING ATTRIBUTES OF MULTIPLE FAULT SURFACES IN REAL TIME

(71) Applicant: Landmark Graphics Corporation, Houston, TX (US)

(72) Inventors: Baiyuan GAO, Austin, TX (US); Jesse Methias LOMASK, Houston, TX (US); Ashwani DEV, Houston, TX (US)

(73) Assignee: Landmark Graphics Corporation, Houston, TX (US)

(21) Appl. No.: 16/061,637

(22) PCT Filed: Mar. 31, 2016
(86) PCT No.: PCT/US2016/025205

§ 371 Date: Jun. 12, 2018

(51) Int. Cl. G01V 1/34; G06T 17/20

(52) U.S. Cl. CPC G01V 1/345; G06T 17/20; G01V 2210/74; G01V 2210/72; G01V 2210/642

(57) ABSTRACT

Systems and methods for visualizing attributes of multiple fault surfaces in real time by calculating the attributes as each respective fault surface is picked.

### FIELD OF THE DISCLOSURE

The present disclosure generally relates to systems and methods for visualizing attributes of multiple fault surfaces in real time. More particularly, the present disclosure relates to visualizing attributes of multiple fault surfaces in real time by calculating the attributes as each respective fault surface is picked.

### BACKGROUND

Understanding a fault system and its geometrical relationship with the surrounding lithology is crucial to the geophysical and geological interpretation of a formation for locating oil and gas deposits. Calculating fault surface attributes on a picked fault typically provides an understanding of the fault system and its geometrical relationship with the surrounding lithology because the attributes enable the interpretation of the fault corrugations, fault movement/formation, and the relative stress change. The attributes also enable the identification of areas of potential high fracture density.

Conventional techniques for visualizing attributes of a fault surface are, however, currently limited to calculating the attributes on a cross section of the fault surface and manually calculating the attributes of a single fault surface after it is reoriented. In either case, the process is time consuming and/or prone to errors if less than the entire fault surface is used to calculate the attributes. Regardless, there is no technique that visualizes attributes of multiple fault surfaces in real time by calculating the attributes as each respective fault surface is picked.

### BRIEF DESCRIPTION OF THE DRAWINGS

The present disclosure is described below with references to the accompanying drawings in which like elements are referenced with like reference numerals, and in which:

FIG. 1 is a flow diagram illustrating one embodiment of a method for implementing the present disclosure.

FIG. 2. is a 3D display illustrating fault surfaces picked in step 102 of FIG. 1.

FIG. 3. is a 3D display illustrating a fault surface from FIG. 2 that is gridded and meshed in step 104 for calculating local normal vectors in step 106 of FIG. 1.

FIG. 4. is a schematic diagram illustrating a local normal vector used to calculate dip-angle attributes and dip-azimuth attributes in step 108 of FIG. 1.

FIG. 5. is a 3D display illustrating the rotation of a fault surface in step 112 of FIG. 1.

FIGS. 6A-6C. are 3D displays illustrating the same fault surface from FIG. 2 with the dip angle attributes, the dip azimuth attributes and the curvature attributes, respectively.

FIGS. 7A-7C. are histograms of the dip angle attributes, the dip azimuth attributes and the curvature attributes illustrated in FIGS. 6A-6C, respectively.

FIG. 8 is a block diagram illustrating one embodiment of a computer system for implementing the present disclosure.

### DETAILED DESCRIPTION OF THE PREFERRED EMBODIMENTS

The present disclosure overcomes one or more deficiencies in the prior art by providing systems and methods for visualizing attributes of multiple fault surfaces in real time by calculating the attributes as each respective fault surface is picked.

In one embodiment, the present disclosure includes a method for a method for visualizing attributes of a fault surface in real-time, which comprises: a) picking a fault surface; b) generating a grid and a mesh for the fault surface in a three-dimensional space, wherein the mesh includes one or more units and a plurality of mesh points; c) calculating a local normal vector for each unit of the mesh; and d) calculating one or more dip-angle attributes and one or more dip-azimuth attributes for the fault surface using a respective local normal vector and a computer processor.

In another embodiment, the present disclosure a non-transitory storage device tangibly carrying computer executable instructions for visualizing attributes of a fault surface in real-time, the instructions being executable to implement: a) picking a fault surface; b) generating a grid and a mesh for the fault surface in a three-dimensional space, wherein the mesh includes one or more units and a plurality of mesh points; c) calculating a local normal vector for each unit of the mesh; and d) calculating one or more dip-angle attributes and one or more dip-azimuth attributes for the fault surface using a respective local normal vector.

In yet another embodiment, the present disclosure includes a non-transitory storage device tangibly carrying computer executable instructions for visualizing attributes of a fault surface in real-time, the instructions being executable to implement: a) picking a fault surface; b) generating a grid and a mesh for the fault surface in a three-dimensional space, wherein the mesh includes one or more units and a plurality of mesh points; and c) calculating one or more curvature attributes for the fault surface using at least six of the plurality of mesh points.

The subject matter of the present disclosure is described with specificity; however, the description itself is not intended to limit the scope of the disclosure. The subject matter thus, might also be embodied in other ways, to include different structures, steps and/or combinations similar to and/or fewer than those described herein in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present disclosure may be applied in the oil and gas industry, it is not limited thereto and may also be applied in other industries to achieve similar results.

### METHOD DESCRIPTION

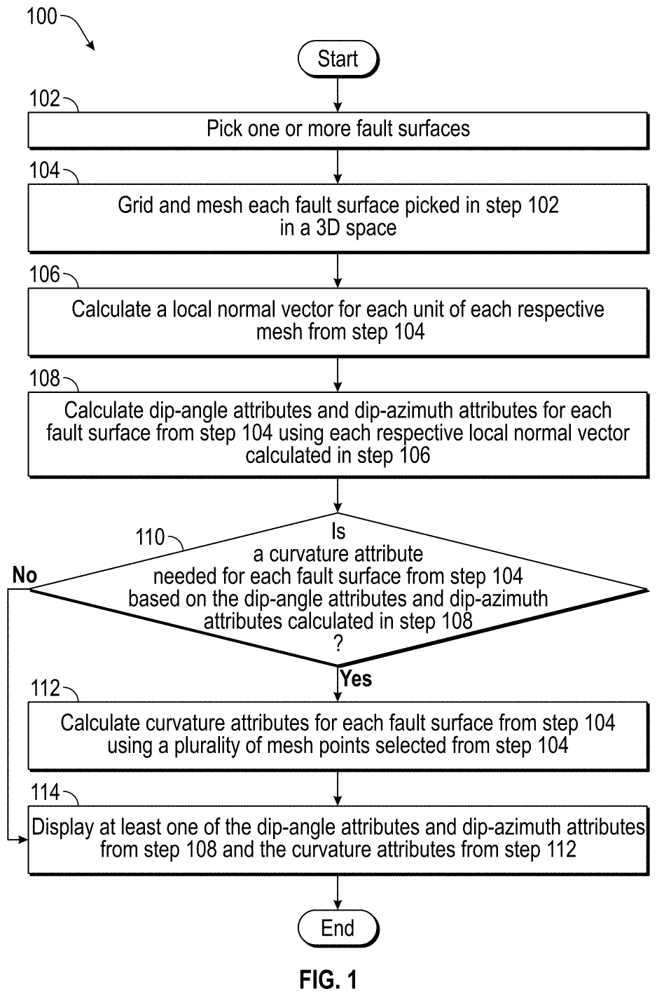

Referring now to FIG. 1, a flow diagram of one embodiment of a method 100 for implementing the present disclosure is illustrated. The method 100 may be implemented on a single fault surface or multiple fault surfaces in real time to visualize the fault surface attributes as each respective fault surface is picked. The method 100 may be performed during three dimensional (3D) seismic interpretations and focuses on extracting the attributes along fault surfaces. The method 100 also enables seismic interpreters to gather and visualize geometric information representing the fault surfaces instantaneously and provides detailed data for further geological analysis.

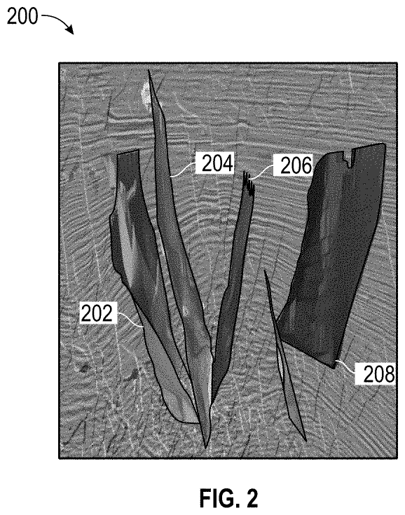

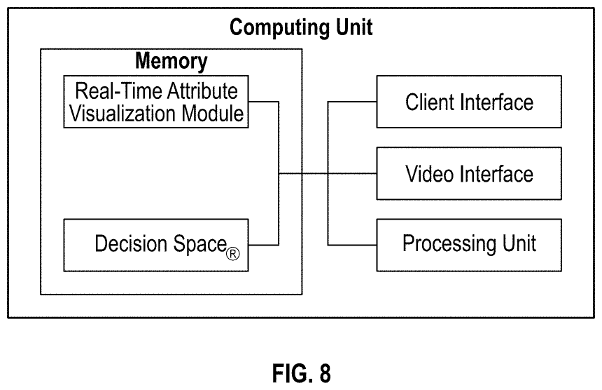

In step 102 one or more fault surfaces are automatically picked using techniques well known in the art such as, for example, automatic tracking and semi-automatic tracking. Alternatively, one or more fault surfaces may be manually picked using the client interface and/or the video interface described further in reference to FIG. 8. In FIG. 2, the 3D display 200 illustrates real fault surfaces 202-208 picked by automatic tracking.

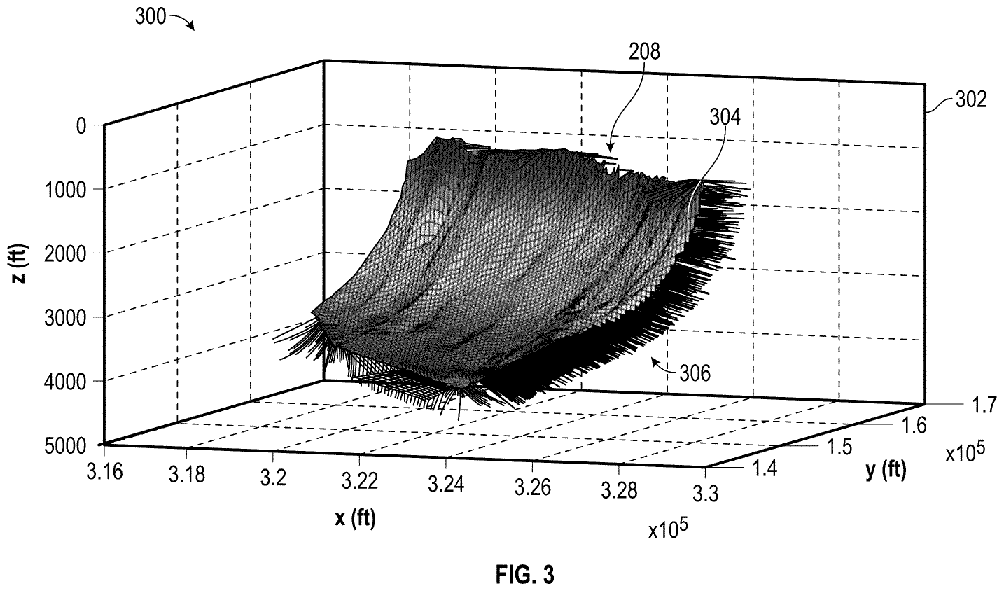

In step 104, each fault surface picked in step 102 is gridded and meshed in a 3D space using techniques well known in the art. In FIG. 3, the 3D display 300 illustrates one of the fault surfaces 208 picked in step 102 that is gridded 302 and meshed 304 in a 3D space comprising x, y, z dimensions of the fault surface in feet. The fault surface 208 is about 10 kft in length and 3 km in height. A quadratic mesh 304 is preferably used to yield better calculations than the traditional triangular mesh. Each mesh unit is 50 ft. by 50 ft. and comprises a plurality of mesh points. The mesh unit size can be changed according the scale of the fault surfaces.

In step 106, a local normal vector is calculated for each unit of each respective mesh from step 104 using techniques well known in the art. Each local normal vector is thus, perpendicular to the respective fault surface, which ensures that the attributes of each fault surface are captured. In FIG. 3, the 3D display 300 illustrates the local normal vectors 306 calculated for each unit of the quadratic mesh.

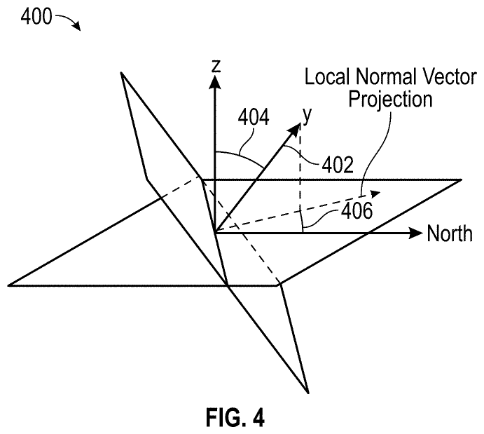

In step 108, dip-angle attributes and dip-azimuth attributes are calculated for each fault surface from step 104 using each respective local normal vector calculated in step 106. Each dip-angle attribute represents the angle between the respective local normal vector and the z axis. Each dip-azimuth attribute shows the dipping direction of the fault surface and represents the angle between a projection of the respective local normal vector and North. In FIG. 4, the schematic diagram 400 illustrates a local normal vector 402 used to calculate a dip-angle 404 and a dip-azimuth 406.

In step 110, the method 100 determines if a curvature attribute is needed for each fault surface from step 104 based on the dip-angle attributes and dip-azimuth attributes calculated in step 108. If a curvature attribute is not needed for each fault surface from step 104, then the method 100 proceeds to step 114. Otherwise, the method 100 proceeds to step 112.

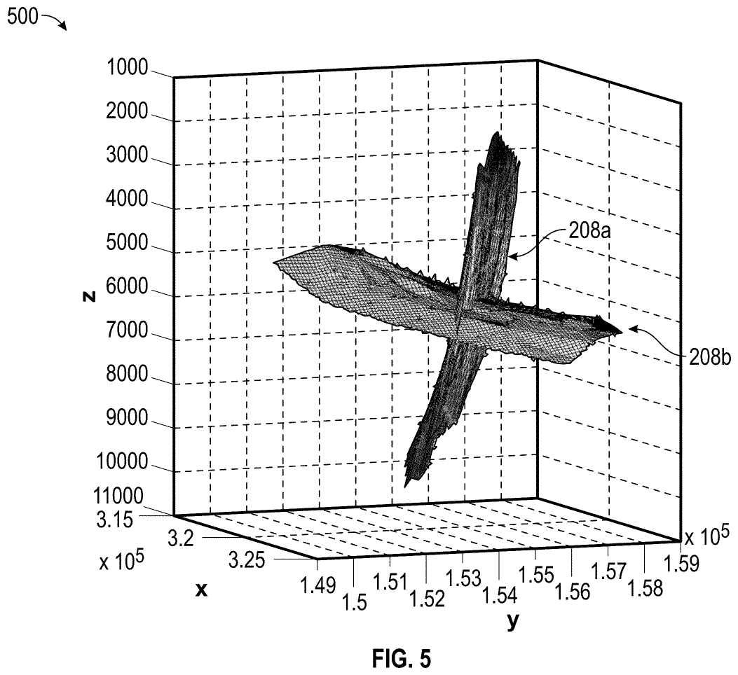

In step 112 curvature attributes are calculated for each fault surface from step 104 using a plurality of mesh points selected from step 104 and the well-known least square root method. Although at least six (6) mesh points are required, preferably ten (10) to fifteen (15) are selected. A curvature attribute describes how bent a fault surface is and can highlight the geological features. When the fault surface is steep, meaning the dip angle is greater than 70 degrees, directly calculating the curvature attributes may be problematic. Thus, a steep fault surface may be rotated to a relative horizontal position to improve the accuracy of the calculation. A rotation matrix may be used in either case:

$$R = ( \begin{matrix}cos θ + {ω}_{x}^{2} ( 1 - cos θ ) & {ω}_{x} {ω}_{y} ( 1 - cos θ ) - {ω}_{z} sin θ & {ω}_{y} sin θ + {ω}_{x} {ω}_{z} ( 1 - cos θ ) \\ {ω}_{z} sin θ + {ω}_{x} {ω}_{y} ( 1 - cos θ ) & cos θ + {ω}_{y}^{2} ( 1 - cos θ ) & - {ω}_{z} sin θ + {ω}_{y} {ω}_{z} ( 1 - cos θ ) \\ - {ω}_{y} sin θ + {ω}_{x} {ω}_{z} ( 1 - cos θ ) & {ω}_{x} sin θ + {ω}_{y} {ω}_{z} ( 1 - cos θ ) & cos θ + {ω}_{z}^{2} ( 1 - cos θ )\end{matrix} )$$

where ω(ωₓ, ω_{y}, ω_{z}) is the rotation axis and θ is the rotation angle. If rotation is not required, then the angle (θ) is equal to zero and R becomes one (1). If rotation is required, then the angle θ is greater than zero. In FIG. 5, the 3D display 500 illustrates the fault surface from step 104 before rotation 208a and after rotation 208b. For each selected mesh point P (x, y, z), the mesh point coordinates are represented by:

P_{(x,y,z)}=P_{(x,y,z)}×R (1)

The polynomial equation for approximating a shape of the fault surface is represented by:

z=ax²+by²+cxy+dx+ey+ƒ (2)

where x,y,z are the mesh point coordinates P_{(x,y,z)} from equation (1) for each selected mesh point. A least square root method is then applied to calculate the coefficients (a, b, c, d, e and f) in equation (2). Because there are more knowns than unknowns, the overdetermined system of equations may be solved using the following equation:

$$X = {( {A}^{T} A )}^{- 1} {A}^{T} B , \\ where X = [ \begin{matrix}a \\ b \\ c \\ d \\ e \\ f\end{matrix} ] , A = [ \begin{matrix}{x}_{1}^{2} & {y}_{1}^{2} & {x}_{1} {y}_{1} & {x}_{1} & {y}_{1} & 1 \\ {x}_{2}^{2} & {y}_{2}^{2} & {x}_{2} {y}_{2} & {x}_{2} & {y}_{2} & 1 \\ … & … & … & … & … & … \\ {x}_{n}^{2} & {x}_{n}^{2} & {x}_{n} {y}_{n} & {x}_{n} & {y}_{n} & 1\end{matrix} ] , B = [ \begin{matrix}{z}_{1} \\ {z}_{2} \\ … \\ {z}_{n}\end{matrix} ] \qquad ( 3 )$$

Then, the coefficients (a, b, c, d and e) may be used in the following equation to obtain the mean curvature attribute at each selected mesh point:

$${k}_{mean} = \frac{a ( 1 - {e}^{2} ) + b ( 1 - {d}^{2} ) - cde}{{( 1 - {d}^{2} + {e}^{2} )}^{3 \text{/} 2}} \qquad ( 4 )$$

Applying the inverse of the rotation matrix, the fault surface may be rotated back to its original position with the curvature attributes.

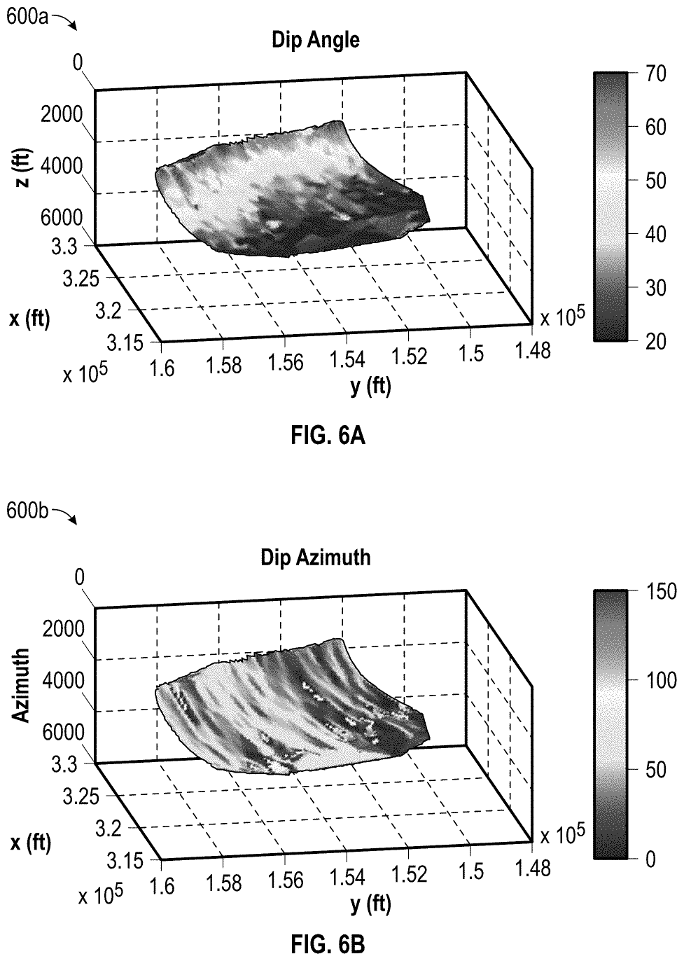

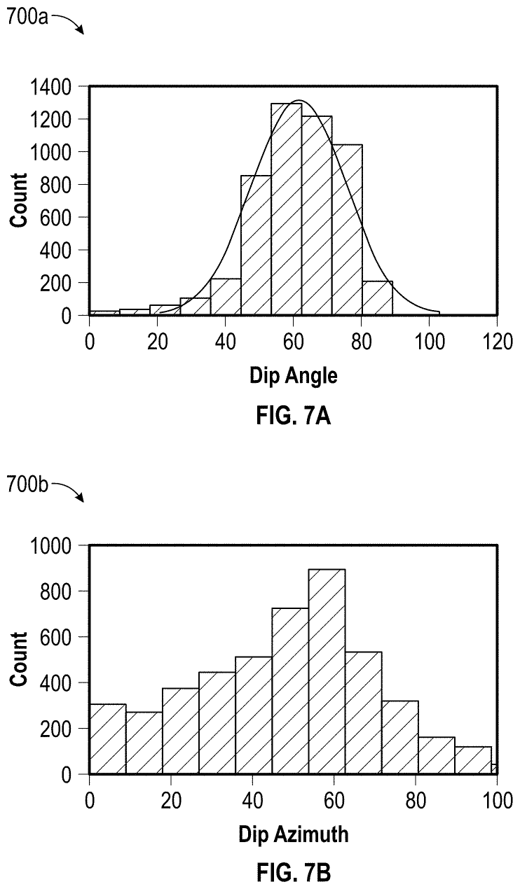

In step 114, at least one of the dip-angle attributes and dip-azimuth attributes from step 108 and the curvature attributes from step 112 are displayed using the video interface described further in reference to FIG. 8. In FIGS. 6A-6C, the 3D displays illustrate the fault surface 208 from step 104 with the dip angle attributes (600a), the dip azimuth attributes (600b) and the mean curvature attributes (600c). The grey-scale bar illustrates the variation in angles for the dip angle (20-70), the dip azimuth (0-150) and the mean curvature (−1 to +1). Optionally, a histogram may also be displayed for the dip-angle attributes and dip-azimuth attributes from step 108 and the curvature attributes from step 112. In FIGS. 7A-7C, histograms of the dip angle attributes (700a), the dip azimuth attributes (700b) and the mean curvature attributes (700c) in FIGS. 6A-6C are illustrated for the fault surface 208 from step 104. The count in FIGS. 7A-7C is the number of the quadratic surfaces. The 3D displays and/or their respective histograms may be used for further iterative statistical analysis of fault distribution, at any given depth and for different size fault surfaces, and attribute distribution to perform paleo stress inversion and predict the paleo environment. Because a tectonic history analysis requires the evaluation of fault surfaces and fault surface attributes, the method 100 results may be used for tectonic history analysis. The method 100 results may also be used to assist in positioning a well. Most importantly, the method 100 enables geological interpretation to be performed within hours for a regional scale compared to current capabilities where it takes weeks without any knowledge of the fault surfaces.

### SYSTEM DESCRIPTION

The present disclosure may be implemented through a computer-executable program of instructions, such as program modules, generally referred to as software applications or application programs executed by a computer. The software may include, for example, routines, programs, objects, components, data structures, etc., that perform particular tasks or implement particular abstract data types. The software forms an interface to allow a computer to react according to a source of input. DecisionSpace® software is a commercial software application marketed by Landmark Graphics Corporation, may be used as an interface application to implement the present disclosure. The software may also cooperate with other code segments to initiate a variety of tasks in response to data received in conjunction with the source of the received data. Other code segments may provide optimization components including, but not limited to, neural networks, earth modeling, history-matching, optimization, visualization, data management, reservoir simulation and economics. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire, and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 8, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-8. The memory therefore, includes a real-time attribute visualization module, which enables steps 104-112 in FIG. 1. The real-time attribute visualization module may integrate functionality from the remaining application programs illustrated in FIG. 8. In particular, DecisionSpace® software may be used as an interface application to perform the remaining steps in FIG. 1. Although DecisionSpace® software may be used as an interface application, other interface applications may be used, instead, or the real-time attribute visualization module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to and/or presently being operated on by the processing unit. By way of example, and not limitation, the computing unit includes an operating system, application programs, other program modules, and program data.

The components shown in the memory may also be included in other removable/non-removable, volatile/nonvolatile computer storage media or they may be implemented in the computing unit through an application program interface (“API”) or cloud computing, which may reside on a separate computing unit connected through a computer system or network. For example only, a hard disk drive may read from or write to non-removable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, voice recognition or gesture recognition, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof

What is claimed:

1. A method for visualizing attributes of a fault surface in real-time, which comprises:
a) picking a fault surface;
b) generating a grid and a mesh for the fault surface in a three-dimensional space, wherein the mesh includes one or more units and a plurality of mesh points;
c) calculating a local normal vector for each unit of the mesh; and
d) calculating one or more dip-angle attributes and one or more dip-azimuth attributes for the fault surface using a respective local normal vector and a computer processor.

2. The method of claim 1, further comprising calculating one or more curvature attributes for the fault surface using at least six of the plurality of mesh points.

3. The method of claim 1, further comprising calculating one or more curvature attributes for the fault surface using at least ten of the plurality of mesh points.

4. The method of claim 1, further comprising displaying the one or more dip-angle attributes, the one or more dip-azimuth attributes and the one or more curvature attributes as the fault surface is picked.

5. The method of claim 4, further comprising positioning a well based on at least one of the one or more dip-angle attributes displayed, the one or more dip-azimuth attributes displayed and the one or more curvature attributes displayed.

6. The method of claim 2, further comprising:
rotating the fault surface from an original position to a new position before the one or more curvature attributes are calculated; and
rotating the fault surface to the original position after the one or more curvature attributes are calculated.

7. The method of claim 1, wherein the mesh generated for the fault surface is a quadratic mesh.

8. The method of claim 1, further comprising repeating steps a)-d) for another fault surface.

9. The method of claim 1, wherein each dip-angle attribute represents an angle between the respective local normal vector and a z-axis and each dip-azimuth attribute represents an angle between a projection of the respective local normal vector and a North direction.

10. A non-transitory storage device tangibly carrying computer executable instructions for visualizing attributes of a fault surface in real-time, the instructions being executable to implement:
a) picking a fault surface;
b) generating a grid and a mesh for the fault surface in a three-dimensional space, wherein the mesh includes one or more units and a plurality of mesh points;
c) calculating a local normal vector for each unit of the mesh; and
d) calculating one or more dip-angle attributes and one or more dip-azimuth attributes for the fault surface using a respective local normal vector.

11. The storage device of claim 10, further comprising calculating one or more curvature attributes for the fault surface using at least six of the plurality of mesh points.

12. The storage device of claim 10, further comprising calculating one or more curvature attributes for the fault surface using at least ten of the plurality of mesh points.

13. The storage device of claim 10, further comprising displaying the one or more dip-angle attributes, the one or more dip-azimuth attributes and the one or more curvature attributes as the fault surface is picked.

14. The storage device of claim 13, further comprising positioning a well based on at least one of the one or more dip-angle attributes displayed, the one or more dip-azimuth attributes displayed and the one or more curvature attributes displayed.

15. The storage device of claim 11, further comprising:
rotating the fault surface from an original position to a new position before the one or more curvature attributes are calculated; and
rotating the fault surface to the original position after the one or more curvature attributes are calculated.

16. The storage device of claim 10, wherein the mesh generated for the fault surface is a quadratic mesh.

17. The storage device of claim 10, further comprising repeating steps a)-d) for another fault surface.

18. The storage device of claim 10, wherein each dip-angle attribute represents an angle between the respective local normal vector and a z-axis and each dip-azimuth attribute represents an angle between a projection of the respective local normal vector and a North direction.

19. A non-transitory storage device tangibly carrying computer executable instructions for visualizing attributes of a fault surface in real-time, the instructions being executable to implement:
a) picking a fault surface;
b) generating a grid and a mesh for the fault surface in a three-dimensional space, wherein the mesh includes one or more units and a plurality of mesh points; and
c) calculating one or more curvature attributes for the fault surface using at least six of the plurality of mesh points.

20. The storage device of claim 19, further comprising:
rotating the fault surface from an original position to a new position before the one or more curvature attributes are calculated; and
rotating the fault surface to the original position after the one or more curvature attributes are calculated.
